(19) United States
(12) Patent Application Publication
(10) Pub. No.: US 2015/0202721 A1
(43) Pub. Date: Jul. 23, 2015

(54) Method for Manufacturing Magazine Box with Binding Strip

(71) Applicant: Shangyu Meisi Crafts Co., Ltd., Shangyu (CN)

(72) Inventor: Honghui Gu, Shangyu (CN)

(73) Assignee: Shangyu Meisi Crafts Co., Ltd.

(21) Appl. No.: 14/549,576

(22) Filed: Nov. 21, 2014

(30) Foreign Application Priority Data
Jan. 22, 2014 (CN) 201410028236.6

(51) Int. Cl. B23K 31/02; A47B 65/00; B23K 11/04

(52) U.S. Cl. CPC B23K 31/02; B23K 11/04; A47B 65/00

(57) ABSTRACT

The invention provides a method for manufacturing a magazine box with binding strip, comprising: inwards bending the C-shaped strip after molding a C-shaped strip to form an inwards bent C-section-shaped flanging, i.e. a C-shaped binding strip; mounting the C-shaped binding strip on the outer edge of the magazine box; welding the C-shaped binding strip after mounting; and pressing the welded C-shaped binding strip, thus obtaining the magazine box with binding strip. The manufacturing method of the invention is simple and highly efficient. Compared with the traditional technology, the present invention reduces the processes by 60%-70% (without the spot welding process and the grinding process) so as to reduce a great deal of human resources.

### CROSS-REFERENCE TO RELATED PATENT APPLICATION

The present patent application claims benefit of Chinese patent application No. 201410028236.6 filed on Jan. 22, 2014, the entire contents of which are incorporated by reference.

### FIELD OF THE INVENTION

The present invention relates to the technical field of binding strip, in particular to a method for manufacturing a magazine box with binding strip.

### BACKGROUND

A classification magazine box is a common office storage product. The magazine box in which various file paper, file folders or magazines are stored is placed on the table top.

At present, there are the following popular types in the market: (1) Prism-shaped mesh type, wherein the sides of the mesh are welding-molded in general; (2) Plastic injection molding; (3) Flanging and welding processes of punched tube bundle boards. The first technology has disadvantages of single product type, no personality, long time of circulation and high labor cost. The plastic in the second type is poor in environmental friendliness and product intensity. The third process is complex, wastes labor and needs a lot of welding technology, of which the meshes after welding should be ground due to burrs, and insufficient grinding easily causes the potential risk and inefficiency.

### SUMMARY

The invention provides a method for manufacturing a magazine box with binding strip, which solves the problems of complex manufacturing processes and low working efficiency in the prior art.

The technical solution of the invention is implemented as follows:

A method for manufacturing a magazine box with binding strip, comprises:

Inwards bending the C-shaped strip after molding a C-shaped strip to form an inwards bent C-section-shaped flanging, i.e. a C-shaped binding strip;

Mounting the C-shaped binding strip on the outer edge of the magazine box;

Welding the C-shaped binding strip after mounting;

Pressing the welded C-shaped binding strip, thus obtaining the magazine box with binding strip.

Preferably, the base and sides of the magazine box are made by punching iron plates respectively.

Preferably, the welding is the flash welding at 50A for 0.02-0.04 s, 0.03 s is more preferred.

Preferably, the pressing pressure is 18-25 tons, 20 tons is more preferred.

Beneficial effects:

(1) The manufacturing method of the invention is simple and highly efficient. Compared with the traditional technology, the present invention reduces the processes by 60%-70% (without the spot welding process and the grinding process) so as to reduce a lot of human resources.

(2) The magazine box manufactured by the method of the invention is higher in safety factor and more durable.

### BRIEF DESCRIPTION OF THE DRAWINGS

To explain the embodiments of the present invention or the technical solution of the prior art more clearly, the necessary accompanying drawings described in the embodiments or the prior art are simply introduced as follows, obviously, the accompanying drawings in the following description are some embodiments of the invention. As for the common technicians in the field, the other accompanying drawings can be obtained based on the accompanying drawings without paying the creative work.

FIG. 1 is the structural schematic view of the binding strip of the magazine box of the invention.

FIG. 2 is the structural schematic view of the magazine box processed by the invention.

In the figures:

1-base, 2-side, 3-binding strip, 31-binding, 32-barrier, 33-open slot, 34-flanging.

### DETAILED DESCRIPTION

The technical solution in the embodiments of the invention is described clearly, completely as follows. Noticeably, the said embodiments are only one part of the invention but not all of them. All the other embodiments which are obtained by the common technicians in the field based on the embodiments of the invention without paying the creative work belong to the scope of protection of the invention.

### Embodiment 1

A method for manufacturing a magazine box with binding strip, comprising:

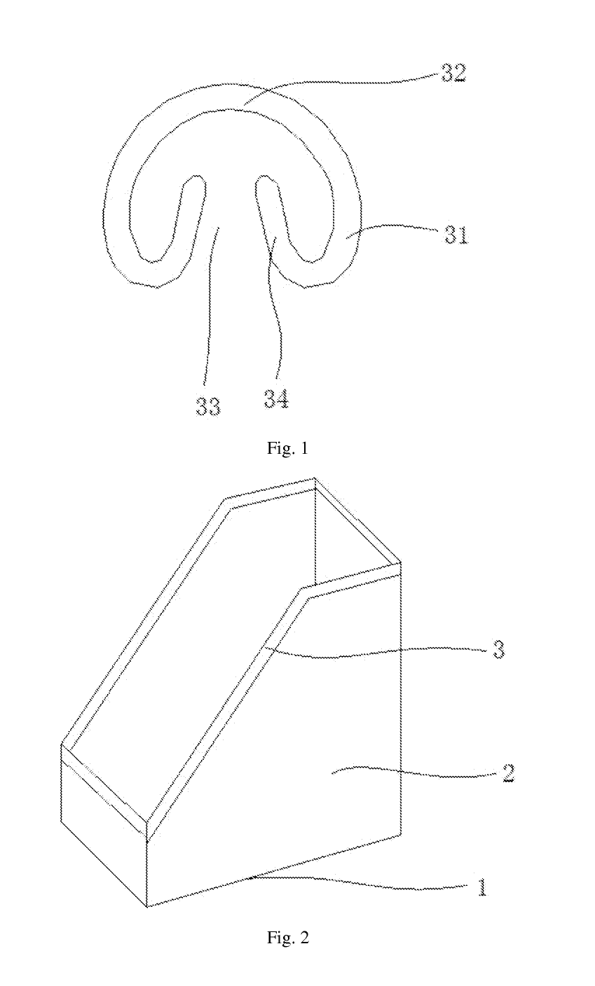

Step S1: inwards bending the C-shaped strip after molding a C-shaped strip to form an inwards bent C-section-shaped flanging, i.e. a C-shaped binding strip, wherein the section of the binding strip is as shown as FIG. 1;

Step S2: mounting the C-shaped binding strip on the outer edge of the magazine box, wherein the outer edge of the base is provided with the binding strip;

Step S3: welding the C-shaped binding strip after mounting, wherein the flash welding is carried out at 50A for 0.02 s-0.04 s, 0.03 s is used in the embodiment;

Step S4: pressing the welded C-shaped binding strip, wherein the pressure is 18-25 tons optionally and 20 tons is used in the embodiment, thus obtaining the magazine box with binding strip.

### Embodiment 2

A method for manufacturing a magazine box with binding strip, comprising:

Step S1: punching iron plates into prism, square or other pattern shaped, and manufacturing the punched iron plates into the prototype of the magazine box;

Step S2: inwards bending the C-shaped strip after molding a C-shaped strip to form an inwards bent C-section-shaped flanging, i.e. a C-shaped binding strip, wherein the section of the binding strip is shown as FIG. 2;

Step S3: mounting the C-shaped binding strip on the outer edge of the magazine in step S1, wherein two ends of the binding strip are connected to the base and the outer edge of the base is provided with the binding strip.

Step S4: welding the C-shaped binding strip after mounting, wherein flash welding is carried out at 50A for 0.02 s-0.04 s optionally, and 0.02 s is used in the embodiment ;

Step S5: pressing the welded C-shaped binding strip, wherein the pressure is 18-25 tons optionally, and 18 tons is used in the embodiment, thus obtaining the magazine box with binding strip.

The spot welding process is not necessary in the invention so as to eliminate the grinding and polishing process due to mesh burrs after welding. Compared with the traditional technology, the present invention reduces the processes by 60%-70% and saves a lot of human resources. In the invention, the outer edge of the magazine box is embedded into the C-shaped binding strip, which improves the stability and intensity of the structure. Two ends of the binding strip are connected to the base of the magazine box, which is convenient to mount, reduces the potential risk and improves the intensity. The technology of the invention is suitably applied to various punched tube bundle boards to meet individual requirements.

The embodiments as claimed above are only the preferred embodiments of the invention and not to limit the invention. Any amendment, equivalent replacement and improvement etc. without departing from the spirits and principles of the invention should be included in the scope of protection of the invention.

What is claimed is:

1. A method for manufacturing a magazine box with binding strip, comprising:
inwards bending the C-shaped strip after molding a C-shaped strip to form an inwards bent C-section-shaped flanging, i.e. a C-shaped binding strip; mounting the C-shaped binding strip on the outer edge of the magazine box; welding the C-shaped binding strip after mounting; and pressing the welded C-shaped binding strip, thus obtaining the magazine box with binding strip.

2. The method for manufacturing a magazine box with binding strip as claimed in claim 1, wherein the base and sides of the magazine box are made by punching iron plates respectively.

3. The method for manufacturing a magazine box with binding strip as claimed in claim 1, wherein the welding is of the flash welding at 50A for 0.02-0.04 s.

4. The method for manufacturing a magazine box with binding strip as claimed in claim 3, wherein the welding is carried out for 0.03 s.

5. The method for manufacturing a magazine box with binding strip as claimed in claim 1, wherein the pressing pressure is 18-25 tons.

6. The method for manufacturing a magazine box with binding strip as claimed in claim 5, wherein the pressure is 20 tons.
